(19) United States
(12) Patent Application Publication
(10) Pub. No.: US 2018/0180504 A1
(43) Pub. Date: Jun. 28, 2018

(54) PRESSURE-MEASURING SENSOR

(71) Applicant: Endress+Hauser GmbH+Co. KG, Maulburg (DE)

(72) Inventors: Thomas Uehlin, Schopfheim (DE); Peter Klöfer, Steinen (DE); Sergej Lopatin, Lörrach (DE)

(21) Appl. No.: 15/536,456

(22) PCT Filed: Nov. 18, 2015
(86) PCT No.: PCT/EP2015/076909

§ 371 Date: Mar. 2, 2018

(30) Foreign Application Priority Data
Dec. 15, 2014 (DE) 102014118616.8

(51) Int. Cl. G01L 19/06; G01L 9/00; G01L 27/00

(52) U.S. Cl. CPC G01L 19/0672; G01L 27/007; G01L 9/0072

(57) ABSTRACT

A pressure-measuring sensor having an electrically-conductive separating diaphragm closing off an interior chamber of the pressure-measuring sensor to the outside, to whose exterior surface a liquid medium under pressure can be applied, and having a device for detecting a diaphragm rupture of the separating diaphragm. At least one electrode is arranged on an interior surface of the separating diaphragm which faces the interior chamber, said electrode being electrically insulated from the separating diaphragm by an insulating layer arranged between the electrodes and the separating diaphragm and mechanically connected to the separating diaphragm, a measuring circuit is connected to a capacitor formed by the separating diaphragm and the electrode, said measuring circuit measuring and monitoring a measured variable dependent upon an electrical property of the capacitor, which is changed by a medium penetrating into the area of the capacitor when a diaphragm rupture of the separating diaphragm occurs.

### CROSS-REFERENCE TO RELATED APPLICATION

The present application is related to and claims the priority benefit of German Patent Application No. 10 2014 118 616.8, filed on Dec. 15, 2014 and International Patent Application No. PCT/EP2015/076909, filed on Nov. 18, 2015, the entire contents of which are incorporated herein by reference.

### TECHNICAL FIELD

The present disclosure relates to a pressure-measuring sensor for measuring a pressure of a liquid medium, with an electrically-conductive separating diaphragm closed off to the outside, to whose exterior surface a liquid medium under the pressure to be measured can be applied.

### BACKGROUND

Pressure sensors are used in industrial pressure-measurement equipment to measure pressures, e.g., in diaphragm seals or in pressure- or differential pressure-measuring instruments.

Pressure sensors normally have an interior chamber which is closed to the outside by a metal separating diaphragm, to whose exterior surface the pressure to be measured by the pressure-measuring sensor can be applied when in operation. Its interior chamber is filled with a pressure-transmitting liquid which is used for transferring the pressure acting upon the separating diaphragm from the outside to a destination connected to the interior chamber.

The separating diaphragms of pressure-measuring sensors are regularly made of metal, such as stainless steel, and have a predetermined thickness which depends upon the design of the pressure-measuring sensor and the pressure range in which it is to be used. Typical values for the thickness of the separating diaphragm fall within the 20 μm to 150 μm range. Due to the functionally determined, low thickness of the separating diaphragm, there is a risk of the separating diaphragm being damaged, either mechanically or chemically. Should damage of this kind penetrate the separating diaphragm at any point, e.g., by corrosion eating through locally, the term used for this is diaphragm rupture.

When a diaphragm rupture occurs, the pressurized medium penetrates into the pressure-measuring sensor at the rupture location and changes the pressure transfer properties of the pressure-measuring sensor. This leads to failure of the pressure-measuring sensor after some time at least. In addition, there is a risk of the liquid-transferring pressure escaping from the pressure-measuring sensor and contaminating the medium in contact with the separating diaphragm.

In DE 101 31 855 A1, a pressure-measuring sensor is described which has a device for detecting a diaphragm rupture. This comprises a sensor which is arranged in a measuring chamber connected to the interior chamber of the pressure-measuring sensor and which, by metrological means, measures and monitors a conductivity or a dielectric constant of the pressure-transmitting medium. This device detects a diaphragm rupture as soon as the liquid medium acting upon the separating diaphragm from the outside penetrates into the pressure-measuring sensor due to a diaphragm rupture, there penetrating as far as the measurement chamber, and thereby resulting in a change in the measured variable being monitored.

In order to minimize as far as possible the adverse consequences of a diaphragm rupture, which may go beyond replacing the defective separating diaphragm, and also to make it possible to take any safety measures which may be necessary, it is important to detect a diaphragm rupture as early as possible.

### SUMMARY

It is an object of the present disclosure to provide a pressure-measuring sensor with which a diaphragm rupture can be detected early on.

To this end, the present disclosure comprises a pressure-measuring device for measuring a pressure of a liquid medium, with an electrically-conductive separating diaphragm closed off to the outside, to whose exterior surface a liquid medium under the pressure to be measured can be applied, which is characterized in that at least one electrode is arranged on an interior surface of the separating diaphragm which faces the interior chamber, said electrode being electrically insulated from the separating diaphragm by an insulating layer arranged between the electrode and the separating diaphragm and mechanically connected to the separating diaphragm, and a measuring circuit connected to a capacitor formed by the separating diaphragm and the electrode, said measuring circuit measuring and monitoring, by metrological means, a measured variable dependent upon an electrical property of the capacitor, which is changed by a medium penetrating into the area of the capacitor when a diaphragm rupture of the separating diaphragm occurs.

A first variant of the present disclosure is characterized in that the medium is electrically conductive, the measured variable is an ohmic resistance of the capacitor, and the measuring circuit comprises a resistance-measuring circuit for measuring the ohmic resistance of the capacitor formed by the separating diaphragm and the electrode.

A development of the first variant is characterized in that the electrode is connected to the measuring circuit by a connecting lead routed through the interior chamber of the pressure-measuring sensor, and the separating diaphragm is connected to the measuring circuit by an electrically-conductive connection in particular, a connection running via a metal support of the pressure-measuring sensor, said support enclosing the interior chamber and being closed to the outside by the separating diaphragm.

A second variant of the present disclosure is characterized in that the measured variable is a measured variable dependent upon a phase shift between alternating current and alternating voltage caused by the capacitor in an alternating current circuit in particular, a dielectric power loss of the capacitor or a tangent of a loss angle dependent upon the phase shift and the measuring circuit contains a measuring circuit in particular, a power-loss-measuring circuit which registers this measured variable by metrological means.

A third variant of the present disclosure is characterized in that two electrodes are arranged on the interior surface of the separating diaphragm which are electrically insulated from each other and from the separating diaphragm by the insulating layer and mechanically connected to the separating diaphragm, each of the electrodes, together with the separating diaphragm, forms a capacitor, the measured variable is a measured variable dependent upon a phase shift between alternating current and alternating voltage caused by the two capacitors connected in series in an alternating current circuit in particular, a dielectric power loss of the series-connected capacitors or a tangent of a loss angle dependent upon the phase shift and the measuring circuit contains a measuring circuit connected to the electrodes in particular, a power-loss-measuring circuit which registers this measured variable by metrological means.

An embodiment of the present disclosure is characterized in that the measuring circuit detects a diaphragm rupture when the measured variable deviates from a reference value measured with an intact separating diaphragm.

A development of the second or third variant is characterized in that the measuring circuit determines the measured variable at at least two different frequencies of the alternating voltage applied via the measuring circuit, and the measuring circuit detects a diaphragm rupture when the two measured variables determined at different frequencies exhibit a frequency dependence.

A development of the development of the second or third variant is characterized in that the frequencies lie below a cut-off frequency above which the measured variable is frequency-dependent when the separating diaphragm is intact, and the frequencies fall within frequency range of 100 Hz to 100 kHz, and, in particular, cover the frequency range from 100 Hz to 100 kHz in particular, by at least one frequency falling within a range of less than one kilohertz, at least one frequency falling within a range of a few kilohertz, and/or at least one frequency falling within a range of more than 10 kHz.

According to a preferred embodiment of the pressure-measuring sensor, the electrode is made of metal in particular, made of silver.

A development of the pressure-measuring sensors according to the present disclosure is characterized in that the insulating layer comprises one or more superimposed layers in particular, a layer of silicon carbide arranged on the separating diaphragm and a layer of diamond-like carbon arranged thereon and each layer consists of a dielectric in particular, made of silicon carbide, diamond-like carbon, or silicon dioxide.

A further development of the pressure-measuring sensors according to the present disclosure is characterized in that the insulating layer comprises at least one layer in particular, a layer of silicon carbide, diamond-like carbon, or silicon dioxide which forms a diffusion barrier to hydrogen.

A further development of the pressure-measuring sensors according to the present disclosure is characterized in that the separating diaphragm has a thickness in the 20 μm to 150 μm range, the insulating layer has a layer thickness in the 0.05 μm to 50 μm range, and/or the electrode has a layer thickness in the 0.1 μm to 10 μm range.

A development of the pressure-measuring sensors according to the present disclosure is characterized in that the interior chamber is filled with a pressure-transmitting liquid which transmits the pressure acting from outside upon the separating diaphragm to a destination connected to the interior chamber in particular, a pressure-measuring chamber equipped with a pressure sensor and forming part of a pressure- or differential pressure-measuring instrument.

The present disclosure further comprises a pressure- or differential pressure-measuring instrument with a pressure-measuring sensor according to the present disclosure which is characterized in that a pressure sensor arranged in a housing is provided, to which pressure acting from outside upon the separating diaphragm can be applied via the pressure-measuring sensor.

In addition, the present disclosure includes a device for detecting a diaphragm rupture of an electrically-conductive separating diaphragm which closes off an interior chamber to the outside and to which a pressurized liquid medium can be applied from the outside, characterized in that at least one electrode is arranged on an interior surface of the separating diaphragm which faces the interior chamber, said electrode being electrically insulated from the separating diaphragm by an insulating layer arranged between the electrode and the separating diaphragm and mechanically connected to the separating diaphragm, and a measuring circuit is provided which is connected to a capacitor formed by the separating diaphragm and the electrode, said measuring circuit measuring and monitoring, by metrological means, a measured variable dependent upon an electrical property of the capacitor, which is changed by a medium penetrating into the area of the capacitor when a diaphragm rupture of the separating diaphragm occurs.

### BRIEF DESCRIPTION OF THE DRAWINGS

The present disclosure and its advantages will now be explained in greater detail on the basis of the figures, which illustrate two embodiments; identical elements are provided with identical reference numerals in the figures.

FIG. 1 shows a pressure-measuring instrument with a pressure-measuring sensor according to the present disclosure;

FIG. 2 shows an equivalent circuit diagram of the capacitor in FIG. 1;

FIG. 3 shows a pressure-measuring instrument with a pressure-measuring sensor with two electrodes;

FIG. 4 shows an equivalent circuit diagram of the capacitors in FIG. 3; and

FIG. 5 shows the electrodes from FIG. 3 arranged on the separating diaphragm.

### DETAILED DESCRIPTION

FIG. 1 shows an embodiment of a pressure-measuring instrument equipped with a pressure-measuring sensor according to the present disclosure, which instrument is used for measuring a pressure p in a liquid medium. The pressure sensor includes a support 1, whose interior chamber 3 is closed off to the outside by an electrically-conductive separating diaphragm 5. Here, one outer edge of the separating diaphragm 5 is connected to an end face of the support 1 facing it by means of a pressure-tight joint for example, a weld. In operation, the exterior surface of the separating diaphragm 5 facing away from the support 1 is acted upon by a liquid medium under pressure p which is to be registered by the pressure-measuring sensor.

The support 1 and the separating diaphragm 3 are made of metal. As protection against corrosion, the separating diaphragm 3 is preferably made of a corrosion-resistant alloy, such as stainless steel or Hastelloy, or has, on its exterior surface, a corrosion-resistant coating 6 which, as an optional feature, is indicated in FIG. 1 only as a broken line. The coating 6 consists, for example, of a precious metal, such as, for example, gold, platinum, or rhodium, or a fluoropolymer, such as, for example, polytetrafluoroethylene (PTFE), perfluoroalkoxy alkanes (PFA), fluorinated ethylene propylene (FEP), or ethylene chlorotrifluoroethylene (ECTFE).

The interior chamber 3 of the pressure-measuring sensor is connected by a pressure-transmission line 7 to a destination to which the sensed pressure p is to be transmitted. In the case of pressure-measuring sensors used in pressure-measuring instruments, the destination is a pressure-measurement chamber 11 arranged within a housing 9 of the pressure-measuring instrument, with a pressure sensor 13 being arranged within said pressure-measurement chamber, said pressure sensor measuring the pressure p applied to it via the pressure-measuring sensor. The interior chamber 3 of the pressure-measuring sensor, the pressure-transmission line 7, and the pressure-measurement chamber 11 are filled with a pressure-transmitting liquid which transmits to the destination the pressure p acting upon the separating diaphragm 5. The pressure-transmitting liquid is a non-conductive, dielectric fluid which is as incompressible as possible and preferably has a low vapor pressure. Suitable here are, for example, the silicone oils or paraffin oils used for this purpose in pressure-measurement technology.

The present disclosure can be used fully analogously even with differential pressure-measuring instruments, which are preferably equipped with two pressure-measuring sensors according to the present disclosure, each of which registers one of the two pressures whose pressure difference is to be measured with the differential pressure-measuring instrument and transmits said pressures to a differential pressure sensor. In precisely the same way, the present disclosure can, of course, be used with pressure-measuring sensors used for other purposes. These include, in particular, pure diaphragm seals, which transmit to a destination a pressure acting upon the pressure-measuring sensor either directly or via a pressure-transmission line connected to the interior chamber of the pressure-measuring sensor.

Pressure-measuring sensors according to the present disclosure are equipped with a device for detecting a diaphragm rupture of the separating diaphragm 5. This comprises at least one electrode 15 arranged on an interior surface of the separating diaphragm 5 so as to face the interior chamber 3 and which, in conjunction with the separating diaphragm 5, forms a capacitor. The electrode 15 is electrically insulated from the separating diaphragm 5 by an insulating layer 17 arranged between the electrode 15 and the separating diaphragm 5 and mechanically connected to the separating diaphragm 5.

The insulating layer 17 consists of a dielectric, such as, for example, silicon carbide (SiC), diamond-like carbon (DLC), or silicon dioxide (SiO2), and, depending upon the selection of dielectric, is applied to the interior surface of the separating diaphragm 5 for example, by plasma-enhanced chemical vapor deposition (plasma CVD), by physical vapor deposition (PVD), by sol-gel deposition or by polymer deposition in particular, of parylenes.

The insulating layer 17 can consist of one or more superimposed layers. Several superimposed layers may be made of the same or different dielectric materials, e.g., made of the materials mentioned above. The advantage of different dielectric materials is that a material which adheres especially well to the metal of the separating diaphragm 5 and which has sufficient elasticity can be selected for the layer disposed directly upon the separating diaphragm 5, such as, for example, silicon carbide (SiC) applied by plasma-enhanced chemical vapor deposition (plasma CVD), while the other materials can be selected with regard to the desired properties of the insulating layer 17.

The insulating layer 17 preferably comprises at least one layer which forms a diffusion barrier against hydrogen. Layers made of the aforementioned dielectrics are suitable for this purpose. Hydrogen is formed, for example, in the case of corrosion of the separating diaphragm 5 caused by the medium or when a redox reaction is triggered on the separating diaphragm 5 by the medium, and can diffuse right through the metal separating diaphragm 5. Here, the diffusion barrier resists hydrogen penetrating into the interior chamber 3 of the pressure-measuring sensor and prevents the pressure-transmitting properties of the pressure-transmitting liquid in the interior of the pressure-measuring sensor from being impaired by the ingress of hydrogen.

The electrode 15 is made of metal, such as silver, and is preferably applied as a metallic coating to the insulating layer 17. Application of the electrode 15 can be carried out by, for example, physical deposition of the metal from the gas phase (PVD).

The separating diaphragm 5 has a comparatively small thickness, predetermined by the design of the pressure-measuring sensor and the pressure range in which it is to be used. Typical values for the thickness of the separating diaphragm 5 fall within the 20 μm to 150 μm range. The insulating layer 17 preferably has a layer thickness in the 0.05 μm to 50 μm range, and the electrode 15 preferably has a layer thickness in the 0.1 μm to 10 μm range.

In the event of a diaphragm rupture, the liquid medium under pressure p penetrates into the area of the capacitor. If the electrical properties of the medium differ from those of the insulating layer 17, the penetrating medium will bring about a change in the electrical properties of the capacitor.

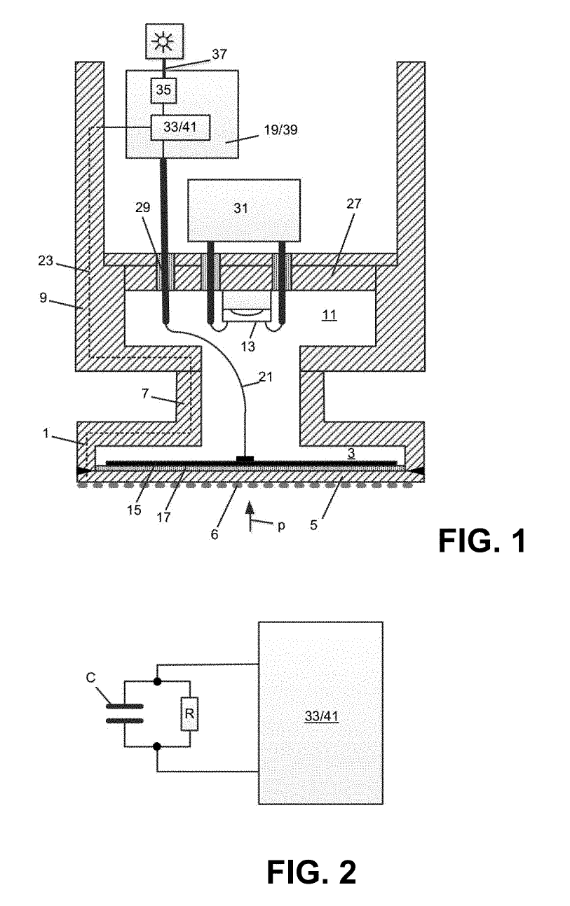

The capacitor formed by electrode 15 and separating diaphragm 5 can be approximately described by an equivalent circuit diagram which is shown in FIG. 2 and which has an ideal capacitor C and an ohmic resistor R connected to it in parallel. While an ideal capacitor in an alternating current circuit causes a phase shift of 90° between current and voltage and has an infinitely large ohmic resistance, the parallel connection of capacitor C and resistor R in an alternating current circuit shown in FIG. 2 causes a phase shift φ which is different from 90° and has a finite ohmic resistance RDC.

Both the phase shift φ and the ohmic resistance RDC of the capacitor formed by the separating diaphragm 5 and the electrode 15 are electrical properties of the capacitor, which are changed by a liquid medium that penetrates after a diaphragm rupture and which has properties that differ from the electrical properties of the insulation layer 17.

According to the present disclosure, in the event of a diaphragm rupture in which liquid medium penetrates into the area of the capacitor, at least one changing property of the capacitor formed by the separating diaphragm 5 and the electrode 15 is registered metrologically by means of a measuring circuit 19 connected to the capacitor, and continuously monitored, and a diaphragm rupture detected when the monitored property of the capacitor changes.

The extent to which a monitored property is changed by penetrating liquid medium depends upon the electrical properties of the liquid medium in comparison with the corresponding electrical properties of the insulation layer 17. Depending upon the nature of the liquid medium, the electrical conductivity or the dielectric constant of the medium play a role here, as do factors such as its polarizability, its ion mobility, and also its dissociability.

When the insulation between the separating diaphragm 5 and the electrode 15 is intact, the ohmic resistance RDC of the capacitor will be extremely high. The ohmic resistance of a capacitor, composed of a 50-μm-thick, stainless-steel separating diaphragm 5, a two-layer insulating layer 17 composed of a 10-μm-thick silicon carbide layer and a 2-μm-thick layer of diamond-like carbon (DLC), and a 0.5-μm-thick electrode 15 made of silver, thus lies, for example, in the megaohm range. If the separating diaphragm 5 is damaged, this will necessarily also affect the insulating layer 17 connected to it, which will result in the pressurized medium penetrating into the capacitor. If a medium with high conductivity, such as a strong electrolyte, forms a conductive bridge between the separating diaphragm 5 and the electrode 15, a short circuit of the capacitor will result, which is accompanied by a drastic decrease in the ohmic resistance. If this separating diaphragm 5 is exposed, for example, to a 10% aqueous solution of ferric chloride, the separating diaphragm 5 will corrode. As soon as the separating diaphragm 5 is corroded through at at least one spatially limited location, the solution will penetrate and cause a short circuit of the capacitor, due to which the ohmic resistance RDC of the capacitor will drop from the megaohm range to a few ohms.

In the case of pressure-measuring sensors used in electrically-conductive media, a measuring circuit 19 is therefore preferably provided which measures the ohmic resistance RDC of the capacitor by metrological means. The measuring circuit 19 is connected to the electrode 15 by a connecting lead 21 running through the interior chamber 3 of the pressure-measuring sensor, the pressure-transmission line 7, the pressure-measurement chamber 11, and an electrical bushing 29 provided in a rear wall 27 of the pressure-measurement chamber 11 which faces away from the pressure-measuring sensor. The measuring circuit 19 is preferably connected to the separating diaphragm 5 by an electrically-conductive connection 23, shown as a broken line in FIG. 1, which runs from the metal-separating diaphragm 5 via the metal support 1 and the pressure-transmission line 7 to the metal housing 9, whence it is connected by a connecting lead 25 to the measuring circuit 19. Connecting the separating diaphragm 5 via the metal support 1 has the advantage that the separating diaphragm 5 exposed during operation to the medium does not need to be provided with an exposed terminal contact.

The measuring circuit 19 can take the form of a separate unit or be part of an electronic measurement module 31 connected to the pressure sensor 13, and comprises a resistance-measuring circuit 33 for metrologically measuring the ohmic resistance RDC of the capacitor, as well as a monitoring unit 35 connected to it which continuously monitors the measured ohmic resistances RDC and detects a diaphragm rupture as soon as the ohmic resistance RDC falls below a reference value determined on the basis of the ohmic resistance RDC present when the separating diaphragm 5 is intact. If a diaphragm rupture is detected, this will be signaled by the monitoring unit 35 via a corresponding output 37. The signal can be given visually, e.g., via a display or, as is shown here, by an LED, or acoustically, e.g., by a signal tone, and/or electrically, e.g., in the form of an electrical signal indicating the damage.

In the case of pressure-measuring sensors which are used in media whose penetration into the capacitor causes only a much lower fall in the ohmic resistance RDC than is the case with highly conductive media, rather than the ohmic resistance RDC, a measured variable dependent upon the phase shift φ caused by the capacitor in an alternating current circuit will instead preferably be measured by metrological means and monitored.

Here, in the embodiment shown in FIG. 1, a measuring circuit 39 can be used instead of measuring circuit 19, which, instead of the resistance-measuring circuit 33, has a measuring circuit 41 which registers this measured variable by metrological means. To do so, a circuit can, for example, be used which determines the phase positions of alternating current and alternating voltage and, on the basis of their difference, determines the phase shift φ. Alternatively, a power-loss-measuring circuit can be used which determines a dielectric power loss of the capacitor or a tangent equivalent to it of a loss angle δ dependent upon the phase shift φ according to δ=90°−|φ|. For this purpose, circuits known from the prior art and frequently referred to as ‘tangent delta’ measuring circuits can be used which measure, by metrological means, the power loss or the tangent of the loss angle tan (δ) by means of a measuring bridge, for example.

Basically, the measured variable can also be compared with a reference value determined with an intact separating diaphragm 5, and a diaphragm rupture be detected when measured variable differs from the reference value.

When the separating diaphragm 5 is intact, the capacitor formed by the separating diaphragm 5 and the electrode 15 is filled with a dielectric solid formed by the insulating layer 17. Capacitors filled with a solid create a frequency-dependent phase shift φ at high frequencies, usually in the gigahertz range, while the phase shift φ has practically no frequency dependence at lower frequencies. In contrast, a liquid contained in a capacitor creates, at a much lower frequency, a frequency dependence of the phase shift φ caused by the capacitor, which does, however, fall as the frequency increases and is virtually negligible in the frequency range in which dielectric solids cause a frequency-dependent phase shift φ. The cause of this is a greater mobility in liquids at the atomic or molecular level which, depending upon the type of liquid, has an effect upon their polarizability which, at lower frequencies, is dependent upon frequency their molecular dynamics, their ion mobility, or their dissociability, and is a significant reason for the size of the resistor R provided in the equivalent circuit diagram shown in FIG. 2.

Accordingly, the measured variable is preferably determined at at least two different frequencies of the alternating voltage applied via the measuring circuit 39 to the capacitor formed by the separating diaphragm 5 and the electrode 15, said frequencies falling within a frequency range which lies below a cut-off frequency above which the capacitor creates a frequency-dependent phase shift φ when the separating diaphragm 5 is intact. In this variant of the present disclosure, a diaphragm rupture is detected when the measured variables measured at different frequencies exhibit a frequency dependence. This will already be the case when at least two measured variables measured at different frequencies differ.

The frequency range within which the liquid medium penetrating into the capacitor causes a frequency dependence of the phase shift φ, and thus of the measured variable dependent upon it, depends upon the properties of the medium. Accordingly, the measured variable is therefore preferably measured at frequencies which cover as large a frequency range as possible in particular, a frequency range of 100 Hz to 100 kHz. Particularly suitable for this purpose are frequencies which have at least one frequency in the range of less than one kilohertz, e.g., 500 Hz, at least one frequency in the range of a few kilohertz, e.g., 5 kHz, and at least one frequency in the range of more than 10 kHz, e.g., 20 kHz. This approach has the advantage of considerably enlarging the range of liquid media whose penetration into the capacitor is detected with the device.

In order to metrologically register the measured variable which depends upon the phase shift φ, an alternating voltage is applied to the capacitor from the measuring circuit 39. In contrast to the measurement of ohmic resistance RDC, the galvanic separation between the separating diaphragm 5 and the electrode 15 caused by the insulating layer 17 is here suspended.

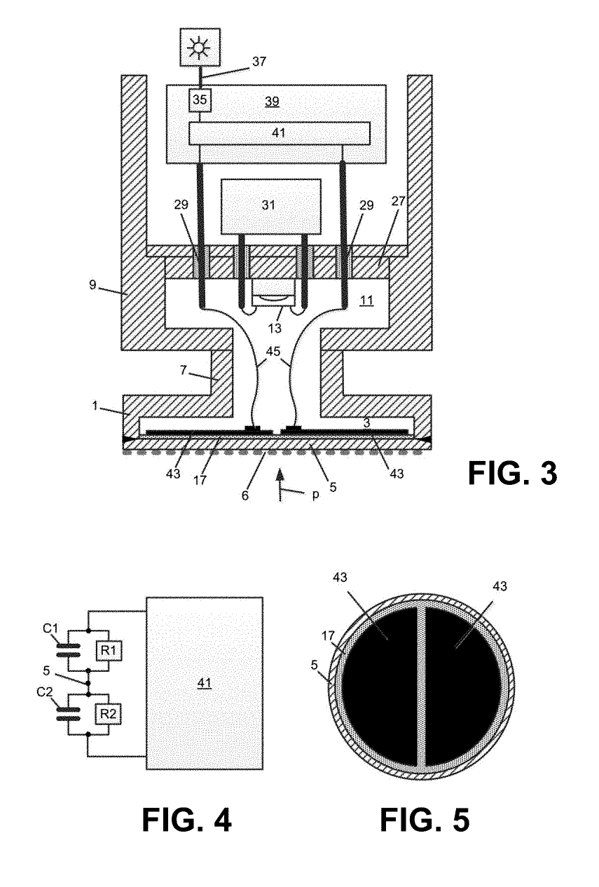

A variant of the present disclosure is shown in FIGS. 3-5 which makes it possible to retain the galvanic separation caused by the insulating layer 17, even when measuring the measured variable dependent upon the phase shift φ. It differs from the embodiment shown in FIG. 1 in that two electrodes 43 separated from each other by a gap are provided on the interior surface of the separating diaphragm 5. In precisely the same way as in the embodiment described above, the electrodes 43 are here too arranged on the insulating layer 17 by which the electrodes 43 are electrically insulated from each other and from the separating diaphragm 5 and mechanically connected to the separating diaphragm 5. As can be seen from FIG. 5, the two electrodes 43 can be identical in shape and be arranged with mirror symmetry on the separating diaphragm 5. This is not, however, necessary for the functioning of the diaphragm rupture detection device, which means that other electrode shapes and electrode arrangements can also be provided as alternatives. Each of the electrodes 43, in conjunction with the separating diaphragm 5, forms a capacitor, and the two capacitors are, from an electrical point of view, connected in series via the separating diaphragm 5.

In precisely the same way as in the previous embodiment, here too a measured variable dependent upon a phase shift φ′ between alternating current and alternating voltage, e.g., the dielectric power loss or the equivalent tangent of the loss angle δ′, is metrologically registered and monitored by means of the measuring circuit 39. In contrast to the previous embodiment, the measuring circuit 39 is here, however, not connected to the separating diaphragm 5, but rather connected to the two electrodes 43 by connecting leads 45 running through the interior chamber 3 of the pressure-measuring sensor. The measuring circuit 39 thus registers and monitors a measured variable dependent upon the phase shift δ′ caused by the series-connected capacitors. This measured variable is dependent upon the electrical properties of the two capacitors and thus changes as soon as a medium with electrical properties different from insulating layer 17 penetrates into the area of at least one of the two capacitors following a diaphragm rupture. FIG. 4 shows an equivalent circuit diagram for this in which, in precisely the same way as the previous embodiment, each of the two capacitors is represented by a partial circuit diagram which includes a capacitor C1, C2 and an ohmic resistor R1, R2 connected in parallel to them. The serial connection of the two capacitors effected via the separating diaphragm 5 is here represented by a connecting point between the two partial circuit diagrams which represents the separating diaphragm 5.

This variant offers the advantage that the measurement is carried out via the two electrodes 43, and no electrical connection between the electrodes 43 and the separating diaphragm 5 is thus created by the measuring circuit 39. Here, the insulating layer 17 will still create a galvanic separation when the separating diaphragm 5 is already damaged, but no galvanic connection to one or both of the electrodes 43 has yet resulted from the penetrating medium.

Metrological registration, monitoring, and the detection and signaling of a diaphragm rupture which may have been detected will, with this variant as well, take place in the way described above in connection with the embodiment shown in FIG. 1, wherein the measured variable dependent upon the phase shift φ caused by the capacitor in FIG. 1 is replaced by the measured variable dependent upon the phase shift φ′ caused by the series-connected capacitors in FIG. 3.

Even though the present disclosure is described here on the basis of pressure-measuring sensors, the device according to the present disclosure for diaphragm rupture detection can, of course, be used in other applications as well, in which an electrically-conductive separating diaphragm closes off an interior chamber to the outside and to which a pressurized liquid medium can be applied from the outside.

1-15. (canceled)

16. A pressure-measuring device, comprising:
a housing forming an interior chamber, the interior chamber having an opening;
an electrically-conductive separating diaphragm disposed over the opening and enclosing the interior chamber, the separating diaphragm embodied to contact a liquid medium on a first side of the separating diaphragm and to separate the liquid medium from the interior chamber, wherein the liquid medium is under pressure;
an insulating layer disposed on a second side of the separating diaphragm, the second side facing the interior chamber;
a first electrode disposed on the insulating layer, wherein the first electrode is electrically insulated from the separating diaphragm by the insulating layer, and wherein the first electrode, the insulating layer, and the separating diaphragm together form a first capacitor; and
a measuring circuit connected to the first capacitor and embodied to measure and to monitor by metrological means a measured variable dependent upon an electrical property of the capacitor, the electrical property changeable by the liquid medium penetrating into the first capacitor.

17. The pressure-measuring device of claim 18, wherein when the liquid medium is electrically conductive, the measured variable is an ohmic resistance of the first capacitor, and the measuring circuit includes a resistance-measuring circuit configured to measure the ohmic resistance of the first capacitor.

18. The pressure-measuring device of claim 18, wherein the first electrode is connected to the measuring circuit by a connecting lead routed through the interior chamber, and the separating diaphragm is connected to the measuring circuit by an electrically-conductive connection running via a metal support of the housing.

19. The pressure-measuring device of claim 18, wherein the measuring circuit is configured to apply an alternating voltage to the first capacitor, wherein the measured variable is dependent upon a phase shift between an alternating current and the alternating voltage caused by the capacitor, and the measured variable is a dielectric power loss of the capacitor or a tangent of a loss angle, and wherein the measuring circuit includes a power-loss measuring circuit configured to register the measured variable by metrological means.

20. The pressure-measuring device of claim 18, further comprising a second electrode disposed on the insulating layer, the second electrode electrically insulated from the first electrode and from the separating diaphragm by the insulating layer, wherein the second electrode, the insulating layer, and the separating diaphragm together form a second capacitor,
wherein the measuring circuit is configured to apply an alternating voltage to the first capacitor and to the second capacitor,
wherein the measured variable is dependent upon a phase shift between an alternating current and the alternating voltage caused by the two capacitors connected in series via the separating diaphragm, and the measured variable is a dielectric power loss of the series-connected capacitors or a tangent of a loss angle, and
wherein the measuring circuit includes a power-loss-measuring circuit configured to register the measured variable by metrological means.

21. The pressure-measuring device of claim 18, wherein the measuring circuit is configured to detect a separating diaphragm rupture when the measured variable deviates from a reference value measured with an intact separating diaphragm.

22. The pressure-measuring device of claim 21, wherein the measuring circuit is configured to determine the measured variable at at least two different frequencies of the alternating voltage, and wherein the measuring circuit is configured to detect a separating diaphragm rupture when the measured variable determined at different frequencies exhibits a frequency dependence.

23. The pressure-measuring device of claim 24, wherein the at least two frequencies are below a cut-off frequency above which the measured variable is frequency-dependent when the separating diaphragm is intact, and the at least two frequencies are within a frequency range from 100 Hertz (Hz) to 100 kHz.

24. The pressure-measuring device of claim 25, wherein the measuring circuit is configured to determine the measured variable at three different frequencies of the alternating voltage, and wherein a first frequency is less than 1000 Hz, a second frequency is between 1 kHz and 10 kHz, and a third frequency is greater than 10 kHz.

25. The pressure-measuring device of claim 18, wherein the electrode is made of silver.

26. The pressure-measuring device of claim 18, wherein the insulating layer includes one or more superimposed layers of dielectric material, the dielectric material selected from the group consisting of silicon carbide, diamond-like carbon, and silicon dioxide.

27. The pressure-measuring device of claim 28, wherein the insulating layer includes a layer of silicon carbide disposed on the separating diaphragm and a layer of diamond-like carbon disposed on the silicon carbide layer.

28. The pressure-measuring device of claim 18, wherein the insulating layer includes at least one layer of silicon carbide, diamond-like carbon, or silicon dioxide to form a diffusion barrier to hydrogen.

29. The pressure-measuring device of claim 18, wherein the separating diaphragm has a thickness from 20 micrometers (μm) to 150 μm, the insulating layer has a layer thickness from 0.05 μm to 50 μm, and the electrode has a layer thickness from 0.1 μm to 10 μm.

30. The pressure-measuring device according to claim 18, further comprising a pressure-measuring chamber including a pressure sensor, wherein the interior chamber is filled with a pressure-transmitting liquid whereby a pressure acting upon the first side of the separating diaphragm is transmitted to the pressure-measuring chamber and to the pressure sensor.

31. A pressure-measuring instrument, comprising:
a pressure-measuring device comprising
a housing forming an interior chamber, the interior chamber having an opening,
an electrically-conductive separating diaphragm disposed over the opening and enclosing the interior chamber, the separating diaphragm embodied to contact a liquid medium on a first side of the separating diaphragm and to separate the liquid medium from the interior chamber, wherein the liquid medium is under pressure,
an insulating layer disposed on a second side of the separating diaphragm, the second side facing the interior chamber,
a first electrode disposed on the insulating layer, wherein the first electrode is electrically insulated from the separating diaphragm by the insulating layer, and wherein the first electrode, the insulating layer, and the separating diaphragm together form a first capacitor, and
a measuring circuit connected to the first capacitor and embodied to measure and to monitor by metrological means a measured variable dependent upon an electrical property of the capacitor, the electrical property changeable by the liquid medium penetrating into the first capacitor.

32. A device for detecting a diaphragm rupture, comprising:
an electrically-conductive separating diaphragm disposed on and enclosing an interior chamber, the separating diaphragm embodied to contact a pressurized liquid medium outside the interior chamber;
at least one electrode disposed on an interior surface of the separating diaphragm which faces the interior chamber, the at least one electrode electrically insulated from the separating diaphragm by an insulating layer disposed between the at least one electrode and the separating diaphragm and mechanically connected to the separating diaphragm; and
a measuring circuit connected to a capacitor formed by the separating diaphragm and the at least one electrode, the measuring circuit configured to measure and to monitor, by metrological means, a measured variable dependent upon an electrical property of the capacitor, which is changed by the medium penetrating into an area of the capacitor upon a diaphragm rupture of the separating diaphragm.
